(19) United States
(12) Patent Application Publication
(10) Pub. No.: US 2022/0283642 A1
(43) Pub. Date: Sep. 8, 2022

(54) SOCIAL WEARABLE COMPANION SYSTEMS AND DEVICES

(71) Applicant: The Regents of the University of California, Oakland, CA (US)

(72) Inventors: Katherine Isbister, Santa Cruz, CA (US); Ella Dagan Peled, Santa Cruz, CA (US)

(21) Appl. No.: 17/653,858

(22) Filed: Mar. 7, 2022

Related U.S. Application Data
(60) Provisional application No. 63/157,135, filed on Mar. 5, 2021.

(51) Int. Cl. G06F 3/01; G06F 3/16

(52) U.S. Cl. CPC G06F 3/016; G06F 3/011; G06F 3/16

(57) ABSTRACT

Presented herein is Flippo, a social wearable creature configured and designed to support people to take breaks away from their desk and move, as well as to socialize with others by caring for their creature. Flippo may take the shape of a soft and fuzzy bug-like creature, and may “live” on people's shoes. The creature may occasionally nudge them when it needs to move and have social interaction with another creature from its species. It may do this by making sounds and visual effects, and may require that the wearers coordinate shaking their feet and helping the creatures face each other. If Flippo is satisfied with the interaction, it may display a light animation and play ‘happy’ tunes; if not, it may nudge the wearer again. The companion design may advantageously encourage and facilitate co-located social interaction.

### CROSS REFERENCE TO RELATED APPLICATION

The present application claims priority to U.S. Provisional Application 63/157,135, entitled “SOCIAL WEARABLE COMPANION SYSTEMS AND DEVICES,” and filed on Mar. 5, 2021. The entire contents of the above-listed application are hereby incorporated by reference for all purposes.

### TECHNICAL FIELD

This disclosure is directed to systems and methods for social wearable companion technologies.

### BACKGROUND

People tend to engage with various types of electronic screens many hours of each of their days, and they rarely use computer-based technology in co-located social interactions other than passively watching a shared screen together.

Previous research has begun to identify questions and areas to consider for designers who work in the space of Social Wearables (e.g., defined herein as wearable technology that augments co-located social interactions). Research that explores social affordances for co-located interactions and research on using movement to create playful interactions is inspiring.

Commercial development of wearables for shoes has mostly focused on biometrics measures for health, performance and training, tracking GPS signals for safety measures, or comfort (e.g. Nike's self-lacing shoes). There are a few commercial wearable shoe-accessories designed as game controllers to support screen based interaction or virtual-reality. There is research on foot-based interaction with various kinds of screens, in virtual and mixed environments, and using tangible objects (e.g., balls).

Wearable fitness trackers that attempt to encourage and support people's physical activity are abundant, and there are also research projects using wearables to track and encourage movement. For example, Pediluma is a shoe-accessory wearable that aims to encourage physical activity by tracking and visualizing the wearer's movement.

There are various applications that aim to encourage and support people to take breaks away from their screens. The research design concept Breaktime Barometer took into account the social benefit of taking breaks with other people in the workplace, and the UpTime research project focused on supporting workers' transitions from breaks back to work. Wearables that aim to facilitate co-located social interactions may be used to support icebreaking activity to augment conversation.

There are a few smart pet/robotic companion commercial products and design research projects. For example, Ref is a design concept of a wearable wrist worn creature that responds to the wearer's pulse measures by changing its shape, with the purpose of making its wearer more aware of their emotional state. In another example, Hooze is a fashion accessory design artifact with playful and zoomorphic qualities, which entices people to touch it. The prototype design used in the research project is an interactive hand-crafted plush toy which has a backstory of being a ‘worried pet.’ It was used primarily as a technology probe for both children and their parents.

Paro is a commercial product that is designed as a cute, furry robotic seal companion for elderly people. It was found to reduce patient stress and also to support and improve the socialization of patients with each other and with caregivers. Tamagotchi is a well-known commercial product that is designed as a display of a virtual pet enclosed in a small plastic device. It is worn on a keychain and the virtual pet needs to be taken care of, i.e., by having daily interaction with its user. The Tamagotchi Connection was introduced in 2004 and, in this version, the virtual pets need to interact with other virtual pets, i.e., by employing Infrared (IR) sensing.

Despite the currently available options for users, there remains a need for improved systems and methods pertaining to social wearable companion technologies.

### SUMMARY

Certain implementations of the disclosed technology are generally directed to potential changes to current socio-spatial practices by creating and testing the use of a social wearable ‘creature.’ Because wearables are worn on people's bodies and accompany them when they are co-located with other people, such a ‘creature’ advantageously holds great potential for positively supporting people's co-located social interactions.

Certain implementations of the disclosed technology may include a wearable configured to utilized the benefits of movement and co-located social experiences in a playful manner, extending previous work by looking at an every-day situation (e.g., working indoors in front of a computer) and enhancing it with playful social wearable creatures that encourage those who wear them to take short breaks with co-located others, and also to move their bodies. Such implementations are motivated at least in part by research establishing the benefits of taking breaks from work and, more particularly, of physical movement and social breaks for knowledge workers.

### BRIEF DESCRIPTION OF THE DRAWINGS

FIG. 1 illustrates an example of a wearable companion in accordance with certain implementations of the disclosed technology.

FIG. 2 illustrates an example of two users who each have a social wearable companion in accordance with certain implementations of the disclosed technology.

FIG. 3 illustrates an example of a wearable companion having a lithium battery in accordance with certain implementations of the disclosed technology.

FIG. 4 illustrates an example of a set of seven social wearable companions in accordance with certain implementations of the disclosed technology.

FIG. 5 illustrates an example of seven users who each have a social wearable companion in accordance with certain implementations of the disclosed technology.

FIG. 6 illustrates an example of a social wearable companion having multiple LED lights in accordance with certain implementations of the disclosed technology.

FIG. 7 illustrates an example of a method in accordance with certain implementations of the disclosed technology.

FIG. 8 illustrates an example of an in-office use case scenario in accordance with certain implementations of the disclosed technology.

### DETAILED DESCRIPTION

A core contribution of the disclosed technology includes Synergistic Social Technology (SST) as a strong concept. Strong concepts are considered intermediate-level knowledge contributions. They “are design elements abstracted beyond particular instances which have the potential to be appropriated by designers and researchers to extend their repertoires and enable new particulars instantiations.” In addition, embodiments include an exploratory social wearable system, which inspired the development of SST, along with design-focused observations based on a preliminary study of the system. A motivation for developing SST as a strong concept included an ongoing interest in sharpening design practice concerning opportunities to foster a sense of community and connection among people who use our interactive technology. The disclosed technology may position the technology as in need of care. Not just care at an individual level, but at a collective level across devices and multiple people. And that this care could, in turn, help to foster connection and community among people who engaged with the technology.

Embodiments may augment co-located socializing (e.g., in the same physical spaces). There is a need to not only enable co-located social interaction, but also design technology that actively and deliberately attempts to improve its quality, value, and extent. “Although designers can never fully predict the social implications of their design, and although the political significance of artifacts changes over time,” they should consider the social implications of their designs. Further, “every technology can deliberately or inadvertently impact psychological wellbeing.” Therefore it is very important to address the neglect of co-located social support head-on. Embodiments may include a system that does not just enable, but actively support and encourage co-located social interaction.

Synergistic Social Technology (SST) generally includes that the technologies are designed to have ‘needs’ that motivate people to engage. As a direct result of responding to these needs, people find themselves interacting with others synchronously and collaboratively. So, by synergistic, it is meant that the technology benefits from getting its ‘need’ met by the people's engaging with it, while people benefit from being ‘encouraged’ to engage in social interaction.

Designers generally consciously design compelling and essential interactions as part of systems. These interactions should create synergies between meeting the ‘need(s)’ of the system and social interaction among the people who use it. Ideally, these interactions also aid people in conceiving of themselves as part of a community of care, thinking beyond the individual level of interaction.

‘Need(s)’ do not necessarily mean the technology's technical requirements (such as a need for electric power). Needs are casted in an animistic sense: the designers craft a framing story for the technology that assigns ‘need(s)’ that must be met in socially beneficial ways by the people who use the system. One can imagine situations in which the technical requirements of a system might incidentally drive social interaction. For example, electric vehicles need charging. When charging a vehicle in a public setting (e.g., a parking lot), people may encounter others and consequently interact with them. It may also lead to people interacting with others by forming social clubs around improving, or even just showing off their vehicles to one another, or creating services for repair and maintenance. However, these possible interactions between people are not required by the design of the technology and are thus auxiliary effects.

The SST concept draws upon a range of HCl theoretical frames while adding a collective-minded, animistic perspective. It focuses on systems of humans and technology working together. Core principles of SST may include: systems designed with ‘need(s)’: by crafted a framing story that casts them in an animistic sense (e.g., ‘needing’ to connect devices after several hours of actively using them because the devices ‘rely on each other to survive’); the ‘need(s)’ encourage the people who use the system to interact because they are compelling and essential for them as humans (e.g., taking a break from the screen); when people fulfill the system's ‘need(s)’ they experience positive social implications (e.g., people meet to exchange access information in order to connect their devices); the interactions are designed to work beyond the individual level of use—they are designed to foster a sense of community (e.g. people rely on each other for the exchange of information, they cannot complete a task on their own); and building ‘synergies’ between real human needs and the ‘need(s)’ of the system.

Implementations of the disclosed technology generally continue to unpack and study the design space of Social Wearables following a Research through Design (RtD) approach, and may include the design, creation, and testing of a social wearable creature to assess its impact on the wearer's co-located social experience. Such a social wearable creature may advantageously facilitate the emergence of social interaction between wearers and support people to take social breaks. Implementations may explore how the wearer might feel about the driver being the creature, e.g., that it is something that they need to care for and something that engenders interdependence.

In certain embodiments, the wearable may be designed as a small animated creature that needs to move and have social interaction with other creatures of its species in order to survive and, hopefully, ultimately thrive. The creature may be configured to signal to its wearer when it needs interaction, but it may also be configured to respond to any interaction with one or more other creatures if this is initiated by the wearers. One example of such a creature is described herein and is referred to herein as“Flippo”.

In certain embodiments, Flippo may be a social wearable companion that is configured to allow its wearer (also referred to herein as ‘carer’) to know when the creature needs to move and interact with other creatures of its kind. The creature may be configured to provide sound and visual feedback to communicate its needs; for example, the creature may ‘nudge’ its wearer (e.g., vibrate) to indicate that it wishes for the wearer to take care of it. The creature may then display visual feedback and sound effects when it experiences the interaction and movement it needs by playing a short tune and light animation to signal being content, for example. The creature may be further configured to ‘wake up’ for these experiences randomly or at set intervals.

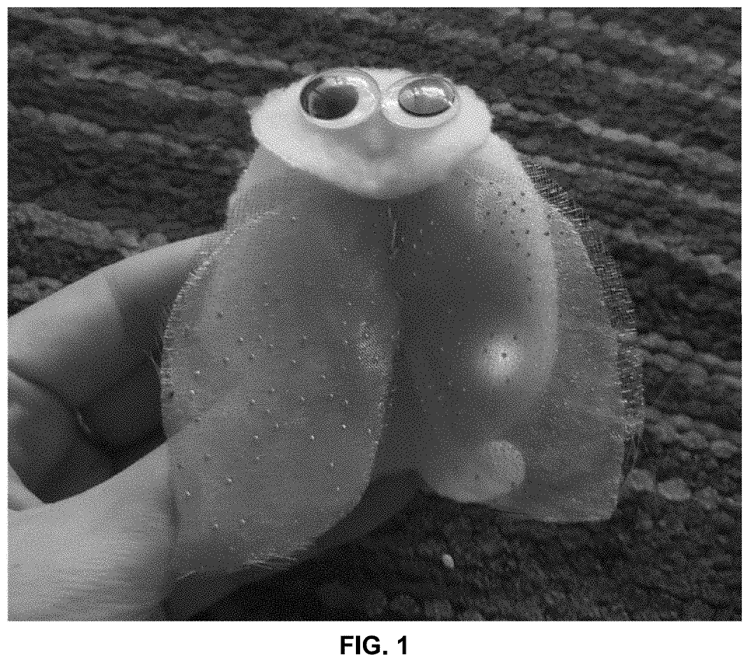

FIG. 1 illustrates an example of a wearable companion in accordance with certain implementations of the disclosed technology. In the example, the creature is named Flippo the Robo-Shoe-Fly social wearable companion and it is designed to look and feel like a cute bug-like creature. The design was inspired by fuzzy moths, and the creature itself was intended to be non-gendered. Flippo was designed to need social interaction and movement occasionally and includes a timer interaction modality, which uses a timer to trigger signals of change in the wearable's state, A fictional backstory was developed describing the flower-like social wearable creatures, that thrived when the wearers' speaking participation levels in a group discussion was balanced. In certain embodiments, Flippo can be used in an office/desk job-like setting, where people usually spend their time sitting in front of a computer. A user having an external reason to move around and socialize might benefit the user and serve as a short ‘brain break.’

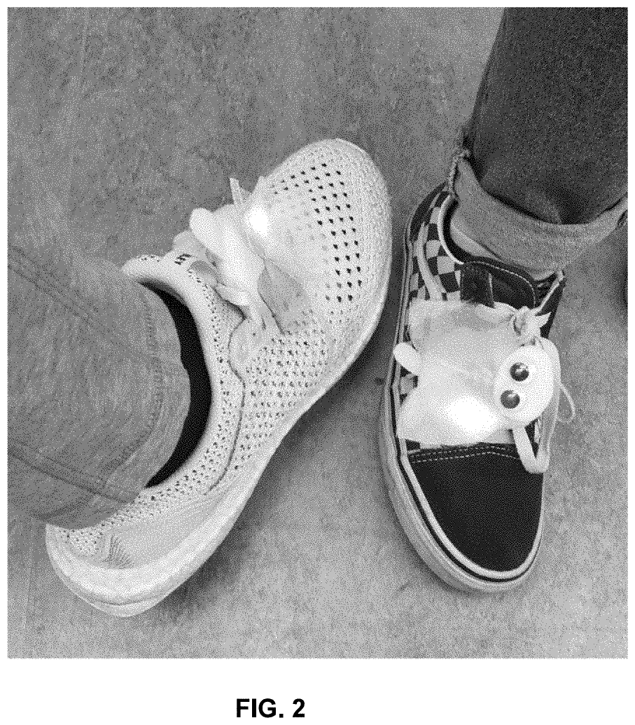

FIG. 2 illustrates an example of two users who each have a social wearable companion in accordance with certain implementations of the disclosed technology. In such an example, Flippo may effectively ‘nudge’ its wearer by playing sounds and light effects when it needs interaction, for example. In response, the wearer may then finding another wearer and the first wearer and the second wearer allow the two creatures engage through each wearer shaking the foot wearing Flippo close by the other wearer.

Interaction between wearable companions advantageously leverages the strong concept of Interdependent Wearables: wearables designed to require shared attention and mutual awareness, with interdependent functionality that encourages and rewards collocated interaction. Certain implementations may include using the Adafruit's Circuit Playground Express (CPX) for its prototyping flexibility, its 10 built-in LEDs ring for visual feedback, its speaker, accelerator, internal clock, and IR sensing.

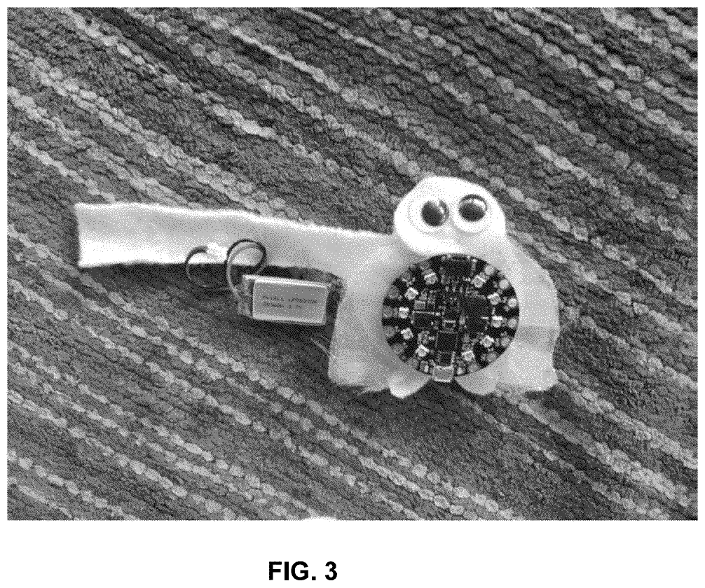

Certain embodiments may include the integration of a soft cover with the creature's design to fit the CPX and a lithium battery, which could also be configured to attach to the wearer's shoelaces. FIG. 3 illustrates an example of this implementation, in which the CPX may be programmed or otherwise configured to utilize its internal clock as a timer. The creature may turn on the first ‘nudge’ (e.g., by playing sound effects and/or a visual light animation) after 60 min, for example, and then again between 30-100 minute intervals, depending on its previous interactions. This first nudge may be meant to let the wearer (and co-located others) know that the creature needs interaction.

Within a certain time, e.g., 10 minutes, of this first nudge, if the device does not register the required interaction (e.g., by receiving an IR signal) it may ‘nudge’ again (e.g., by changing the color of the flashing light display from green to red). However, if the wearer has found another wearer and their device has sensed the IR signal, then the creatures may flash scattered rainbow animation lights and a ‘happy tune,’ for example, as feedback to their wearers that they are content with the interaction. Two wearers of the creatures may need to coordinate shaking their right feet, and face the creatures toward each other in order to send the IR signal. Wearers may also find each other and allow their creatures to interact by shaking their feet even if the creatures did not nudge them to do so. This may also satisfy the creatures' need to interact and may reset their timers to delay their next nudges.

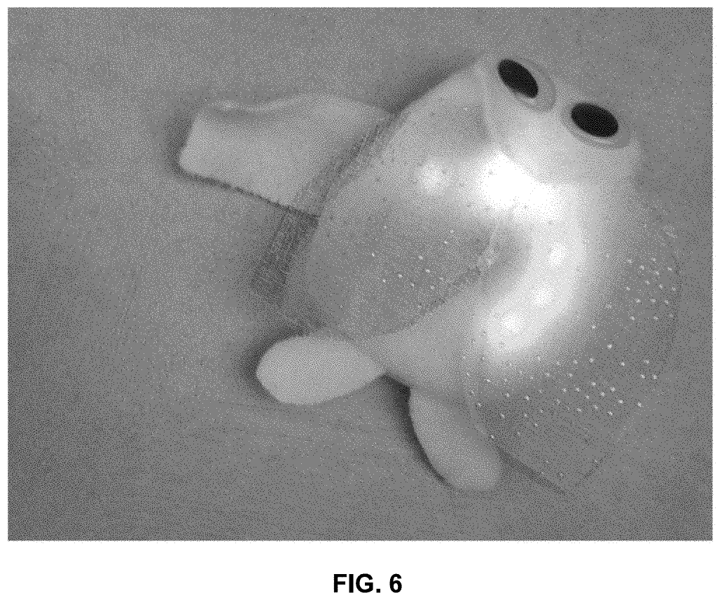

FIG. 6 illustrates an example of a social wearable companion having multiple LED lights in accordance with certain implementations of the disclosed technology. In such embodiments, the creature may be programmed or otherwise configured to display how many times the creature had interactions in which it was content, e.g., by displaying the number (1-5) of green LEDs on the right side of the CPX ring. It may also display how many times it nudged the wearer to interact but did not register a satisfying interaction by displaying the number (1-5) of red LEDs on the left side of the ring.

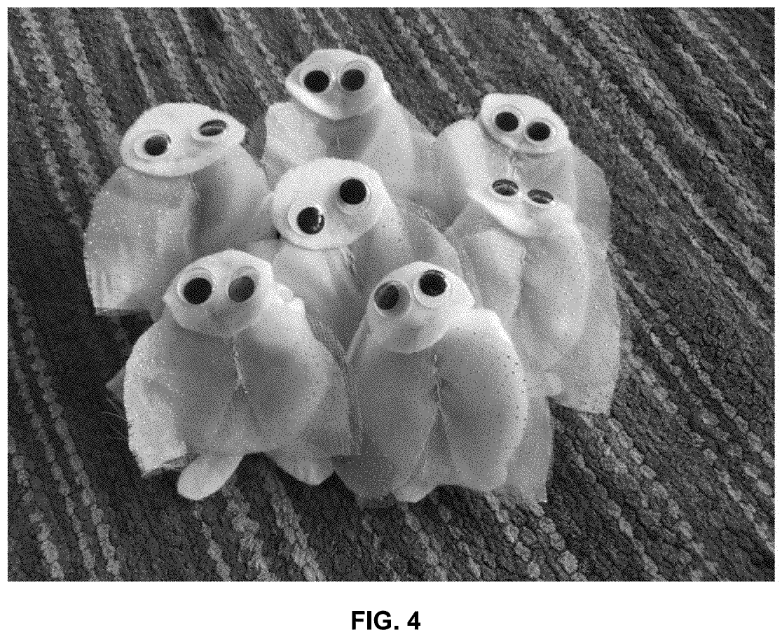

Certain implementations may include following a RtD approach to explore how wearable technology could encourage co-located social interaction, movement and taking breaks. FIG. 4 illustrates an example of a set of seven functioning social wearable companions in accordance with certain implementations of the disclosed technology. In a study, these prototypes were iterated several times, and there was a corresponding exploring of different interaction modalities, timings, and feedback. Variations of the prototype were tested during in-lab group discussions by lab members and invited guests. Feedback was collected from 13 external users. People provided their opinion about their co-located social experience, the wearable creature and its story, and about the interaction and feedback modalities chosen. The study required having at least 2 people participating during the same time and in the same space, and for at least a few consecutive hours, so that using the wearable companion would be experienced as an actual break from their computer/desk work.

In the study, each of the users were instructed to work on their own computer/desk-work, while still paying some attention to the creature's needs and take care of it. Initial results showed that these devices have the potential to encourage and facilitate interaction between co-located people. The 13 participants included 4 graduate and 9 undergraduate students (7 cis female- and 6 cis male-seeming). The participants were divided into 3 groups (2×, 4×, and 7× participants) based on their overlapping schedule availability to afford at least 5 consecutive hours with other participants.

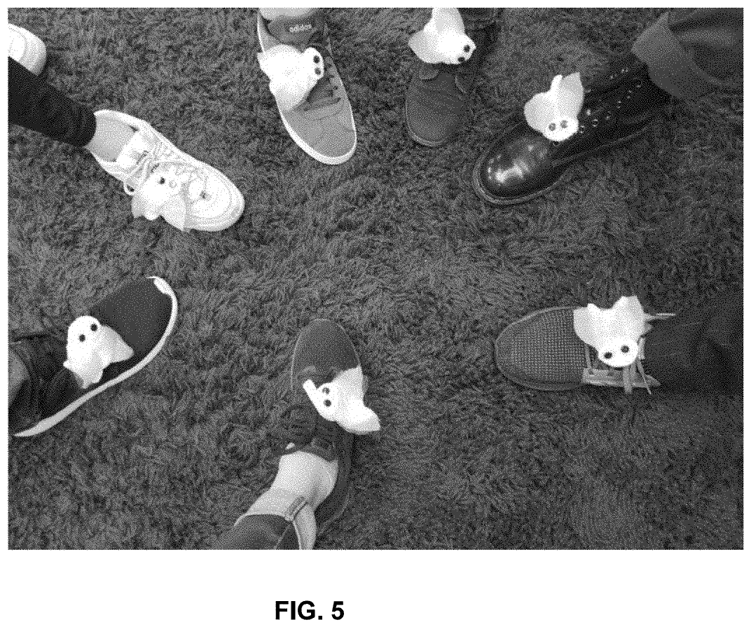

On the day of the users' participation, each wearable was attached to the right outer side of each user's shoe by threading through their shoelaces. FIG. 5 illustrates an example of seven of the users each having a social wearable companion. This allowed the users to move a little bit with it on. The users then went about their work, either in the lab space where they started or in nearby lab spaces. Participants were informed that the wearable would let them know by making a short sound and light effects when it needs to interact with other creatures of its kind and move. It was also explained that this will happen every now and then and, when it does, it would like them to find another person who wears a creature and coordinate with them shaking their feet (e.g., with the creatures facing each other). The participants were informed that the creature would light up and make sounds to let them know it is satisfied. They were also told that they could let the creatures interact even if they did not signal they needed the interaction yet.

At the end of their group session, a semi-structured interview was conducted with each participant for 10-20 minutes. They were asked to fill out an online questionnaire confidentially that had 9 open questions such as: “What did you like about the device?”; “What did you like least about using the device?”; “Did the device affect the social interactions or communications you had while you were wearing it?”; and “Were there any particularly interesting moments you remember?”

Participants in the study generally described the creature as a bug or a fly-like cute little robotic creature. Flippo's appearance was liked and considered to be cute due to its googly eyes, sparkly wings, and its soft and fuzzy texture (N=7). Participants thought it looked ‘goofy’, ‘playful’, ‘friendly’, ‘sweet’, and ‘whimsical’. Some compared it to a pet (N=4), and some enjoyed having it with them as a companion/buddy (N=4). P12 enjoyed having the responsibility to take care of it, writing that “having that sort of dependency, where the device was dependent on me, made me oddly happy.” A few participants anthropomorphized Flippo and projected feeling states onto it (N=2). When reflecting about their experience of wearing the creature, some felt they paid special attention to it (N=5). P12 thought the placement of the wearable on the shoe made it easy to dismiss the creature's nudges when they were occupied. P11 took a preventative approach and changed the manner they sat in order to be able to see their feet (and the creature) “at all times.” A few participants commented that they liked the feedback modalities (N=3). P1 liked that it did not feel intrusive, and P12 thought it was “easy to learn and straightforward to use.”

Suggestions for improvements included adding vibration to the nudges to better attract the wearer's attention, tuning the audio feedback, and adding more complexity in the type of movements required and the intensity of the nudges. P3 felt that the creatures “could be a little more annoying,” and P4 indicated a wish that the sensing interaction between the creatures would happen simultaneously. Some participants commented that they became more aware of their environment and more self-conscious. For example, P9 noticed their surroundings more, and “got many weird looks throughout the day,” and that “the most interesting part” for them was the attention they “received for wearing the creature.” P3 expected to be noticed and found it funny that no one commented on their wearable, and P7 was curious if they were noticed by other people, writing that “I was also wondering if people had noticed the device, even if they didn't specifically ask about it.”

The majority of participants enjoyed aspects of the experience (N=8); for example, P8 wrote it was “a fun little game to keep them fed and happy.” Some participants particularly liked being encouraged to take breaks, and doing so with others. Some liked being nudged to move (N=3), and some liked that it gave them an external reason to socialize N=4), and even brought them in contact with new people. P11 felt they were “more playful and less serious about stuff overall, which was nice.” P12 wrote that wearing the creature “created this newfound sense of responsibility, with relatively low stakes such that it was not anxiety-inducing” and commented how it improved their day quite a bit. They felt it was satisfying “being able to intermittently complete that goal in midst of larger and more stressful academic goals.”

All of the participants except for one (P3, who mostly interacted with people they already knew) discussed how the companion facilitates co-located social interaction. Some mentioned that wearing the creature encouraged them and gave them external reasons to socialize, and some commented how it increased the number of interactions they had with other people. P8 wrote that they “interacted with people a lot more than I would on a normal weekday” and that “it's a good way to find an excuse to interact with other people on a regular basis.” P2 wrote that “it made me take breaks and socialize. Without it, I probably wouldn't have spoken to anyone or left my computer”; and, similarly, P4 wrote “I probably would have stayed behind the desk if I didn't have it on my shoe.”

P12 commented that “it was nice having a mutually defined reason to interact with another person” which they identified as “something that is usually absent in everyday life.” P5 wrote that “the device encouraged social interaction. If the device wasn't there, there would most definitely have been less social interaction. The fact that the device needed to be shook in front of another device on another person meant that I was forced to interact with the other participant to satisfy the needs of the device”; and P10 wrote that “I interacted with more people than I would have otherwise.”

Wearing the creature was used as a conversation piece (N=6). It triggered conversations between participants (e.g., P1 said that “it gave me a reason to talk with strangers (beyond small-talk) who also wore the device”), and also served as a conversation starter between participants and people outside the study (e.g., P8 said that “lots of people not in the study asked about the creature. It was a good talking point”). Some participants mentioned how Flippo worked as an icebreaker: P13 commented that by supporting them to be “goofy and vulnerable,” it helped “form relationships with new people,” and P2 thought that “it made the first interaction with everyone else in the group go a little smoother.”

Finally, P2 thought that the foot shaking interaction was awkward, and they worried about accidentally kicking the other person. P6 and P8 were not pleased with the foot shaking, especially when the IR sensing of the device was not working smoothly. P1 did not like that it “tired one leg asymmetrically,” and P9 was frustrated they had to “run around a lot” to find other creatures near them. P10 felt forced to move, and P1 felt forced to stay close by to other creatures. Interestingly, only three participants (N=3) mentioned the concept of ‘taking breaks’ in their questionnaire responses.

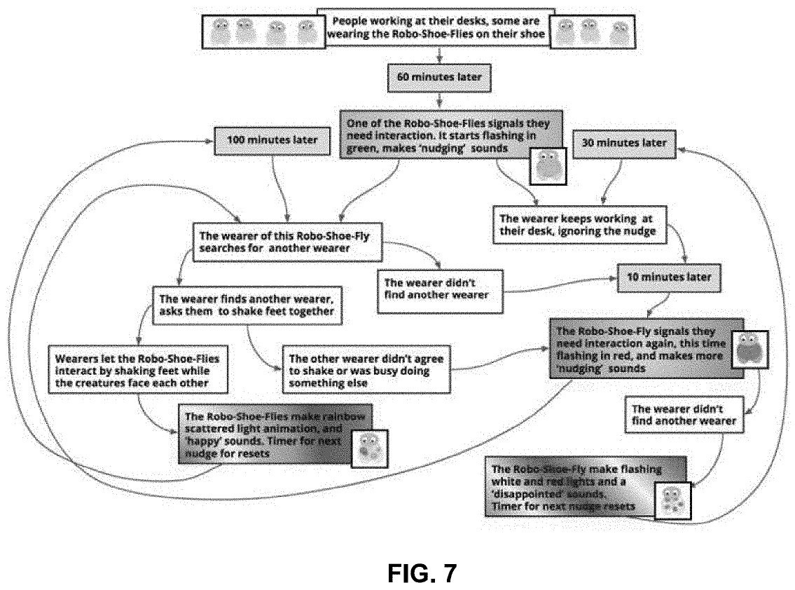

FIG. 7 illustrates an example of a method in accordance with certain implementations of the disclosed technology.

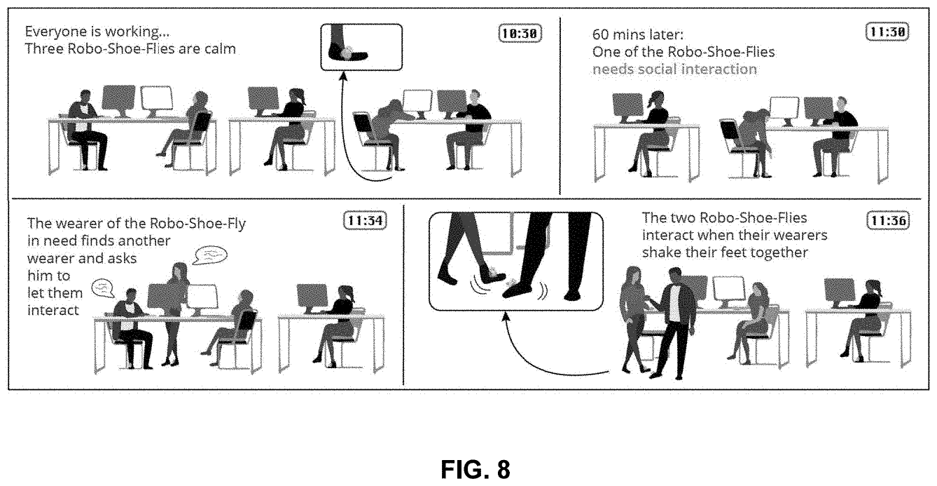

FIG. 8 illustrates an example of an in-office use case scenario in accordance with certain implementations of the disclosed technology.

Presented herein is the Flippo design concept, a social wearable companion to encourage in-person social interaction, moving, and taking short breaks form work. Preliminary analysis shows promising results in that the device may advantageously work to encourage and facilitate co-located social interaction, serve as an external reason to interact with others, increase the number of interactions for users, and be used as a conversation piece.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A social wearable companion, comprising:
a physical body configured to be worn by a user;
a power supply integrated with the physical body;
at least one output device integrated with the physical body; and
a processing unit integrated with the physical body and configured to be powered by the power supply, the processing unit being configured to:
prompt the user, after a predetermined period of time, to physically move, interact with another user, or both physically move and interact with another user; and
responsive to the user physically moving and/or interacting with another user, cause the at least one output device to provide feedback to the user.

2. The social wearable companion of claim 1, wherein the physical body resembles a fictional creature.

3. The social wearable companion of claim 1, wherein the power supply is a lithium battery.

4. The social wearable companion of claim 1, wherein the processing unit includes a Circuit Playground Express (CPX) unit.

5. The social wearable companion of claim 1, further comprising an attachment mechanism configured to secure the social wearable companion to the user.

6. The social wearable companion of claim 5, wherein the attachment mechanism is designed to attach to one or more shoelaces of a shoe that is worn by the user.

7. The social wearable companion of claim 1, wherein the at least one output device includes at least one LED.

8. The social wearable companion of claim 7, wherein the at least one LED is configured to provide a visual indication pertaining to either or both of the prompt and the feedback.

9. The social wearable companion of claim 1, wherein the at least one output device includes at least one speaker device.

10. The social wearable companion of claim 9, wherein the at least one speaker device is configured to provide a visual indication pertaining to either or both of the prompt and the feedback.

11. The social wearable companion of claim 1, wherein the processing unit is further configured to, after a certain period of time, prompt the user again responsive to the user not physically moving and/or interacting with another user.

12. The social wearable companion of claim 1, further comprising a communications device configured to communicate with a communication device of another social wearable companion.

13. The social wearable companion of claim 12, wherein the communications device is an infrared (IR) device.

14. The social wearable companion of claim 13, wherein the IR device is configured to receive a signal from another IR device.

15. The social wearable companion of claim 6, wherein the physical movement includes the user shaking the foot wearing the shoe.

16. The social wearable companion of claim 7, wherein the at least one LED includes a ring of LEDs.

17. The social wearable companion of claim 11, wherein the processing unit is further configured to continue prompting the user at a certain interval until the user physically moves and/or interacts with another user.

18. A system, comprising:
a first social wearable companion for a first user, the first social wearable companion including:
a first physical body configured to be worn by the first user;
a first power supply integrated with the first physical body;
a first output device integrated with the first physical body; and
a first processing unit integrated with the first physical body and configured to be powered by the first power supply, the first processing unit being configured to:
prompt the first user, after a predetermined period of time, to interact with another user; and
responsive to the first user interacting with a second user, cause the first output device to provide first feedback to the first user; and
a second social wearable companion for the second user, the second social wearable companion including:
a second physical body configured to be worn by the second user;
a second power supply integrated with the second physical body;
a second output device integrated with the second physical body; and
a second processing unit integrated with the second physical body and configured to be powered by the second power supply, the second processing unit being configured to:
prompt the second user, after a predetermined period of time, to interact with another user; and
responsive to the second user interacting with the first user, cause the second output device to provide second feedback to the second user.
